(19) United States
(12) Patent Application Publication
(10) Pub. No.: US 2025/0337466 A1
(43) Pub. Date: Oct. 30, 2025

(54) ARTIFICIAL INTELLIGENCE AIDED CARRIER AGGREGATION

(71) Applicant: Samsung Electronics Co., Ltd., Suwon-si (KR)

(72) Inventors: Daoud Burghal, San Jose, CA (US); Yan Xin, Princeton, NJ (US); Bassel Abou Ali Modad, Los Angeles, CA (US); Xiaochuan Ma, Hillsborough, NJ (US); Jianzhong Zhang, Dallas, TX (US); Hao Chen, Allen, TX (US); Yu Zhang, Frisco, TX (US); Yang Li, Plano, TX (US)

(21) Appl. No.: 19/071,621

(22) Filed: Mar. 5, 2025

Related U.S. Application Data
(60) Provisional application No. 63/640,743, filed on Apr. 30, 2024.

(51) Int. Cl. H04B 7/06; G06T 3/4053

(52) U.S. Cl. CPC H04B 7/0626; G06T 3/4053

(57) ABSTRACT

Apparatuses and methods of artificial intelligence based carrier aggregation in wireless communication systems. A method includes receiving channel state information (CSI) of a first carrier component (CC) from a user equipment; preprocessing the CSI of the first CC; and determining CSI of a second CC based on the preprocessed CSI of the first CC and a signal predicting model.

### CROSS-REFERENCE TO RELATED APPLICATION AND CLAIM OF PRIORITY

The present application claims priority under 35 U.S.C. § 119(e) to U.S. Provisional Patent Application No. 63/640,743 filed on Apr. 30, 2024, which is hereby incorporated by reference in its entirety.

### TECHNICAL FIELD

This disclosure relates generally to wireless networks. More specifically, this disclosure relates to methods and apparatuses for artificial intelligence aided carrier aggregation in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for artificial intelligence (AI) aided carrier aggregation in wireless communication systems.

In one embodiment, a computer-implemented method is provided. The method includes: receiving, at an electronic device, channel state information (CSI) of a first carrier component (CC) from a user equipment (UE); preprocessing the CSI of the first CC; and determining CSI of a second CC based on the preprocessed CSI of the first CC and a signal predicting model.

In another embodiment, an electronic device is provided. The electronic device includes a memory and a processor operably coupled to the memory. The processor is configured to: receive CSI of a first CC from a UE; preprocess the CSI of the first CC; and determine CSI of a second CC based on the preprocessed CSI of the first CC and a signal predicting model.

In yet another embodiment, a non-transitory computer readable medium embodying a computer program is provided. The computer program includes program code that, when executed by a processor of an electronic device, causes the electronic device to: receive CSI of a first CC from a UE; preprocess the CSI of the first CC; and determine CSI of a second CC based on the preprocessed CSI of the first CC and a signal predicting model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example network device according to embodiments of the present disclosure;

FIG. 5 illustrates example antenna blocks or arrays according to embodiments of the present disclosure;

FIG. 6 illustrates a diagram of an example signal prediction process in a wireless communication system according to embodiments of the present disclosure;

FIG. 7 illustrates a flow chart of an example signal prediction method according to embodiments of the present disclosure;

FIG. 8 illustrates a flow diagram of an example direct signal prediction method according to embodiments of the present disclosure;

FIG. 9 illustrates an example carrier aggregation based on the resolution algorithm based signal prediction method according to embodiments of the present disclosure;

FIG. 10 illustrates a flow chart of the resolution algorithm based signal prediction method according to embodiments of the present disclosure;

FIG. 11 illustrates an example network structure of a super-resolution algorithm as applied in the method according to embodiments of the present disclosure;

FIG. 12 illustrates an example flow of multi-head self attention (MSA) performed by a SWIN transformers layer (STL) according to embodiments of the present disclosure;

FIG. 13 illustrates an example flow of MSA performed on a cyclically shifted feature according to embodiments of the present disclosure;

FIG. 14 illustrates an example sub-band based sequential signal prediction method according to embodiments of the present disclosure;

FIG. 15 illustrates an example sub-band split under the sub-band based sequential signal prediction according to embodiments of the disclosed concept;

FIG. 16 illustrates an example network structure of a signal prediction model configured to perform the sub-band based sequential signal prediction method according to embodiments of the present disclosure;

FIG. 17 illustrates an example UE selection mechanism according to embodiments of

the present disclosure;

FIG. 18 illustrates an example training enhancement method according to embodiments of the present disclosure; and

FIG. 19 illustrates a flow chart for an example method for artificial intelligence-aided carrier aggregation in wireless communication systems according to embodiments of the present disclosure.

### DETAILED DESCRIPTION

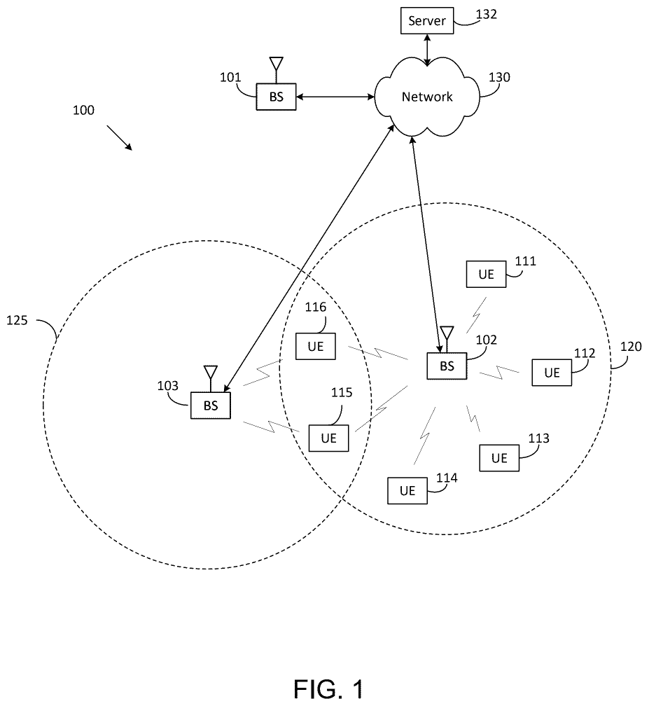

FIGS. 1 through 19, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB (e.g., a base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 may include circuitry, programing, or a combination thereof, for AI-aided carrier aggregation in a wireless communication system. In certain embodiments, one or more of the UEs 111-116 may include circuitry, programming, or combination thereof, to support AI-aided carrier aggregation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

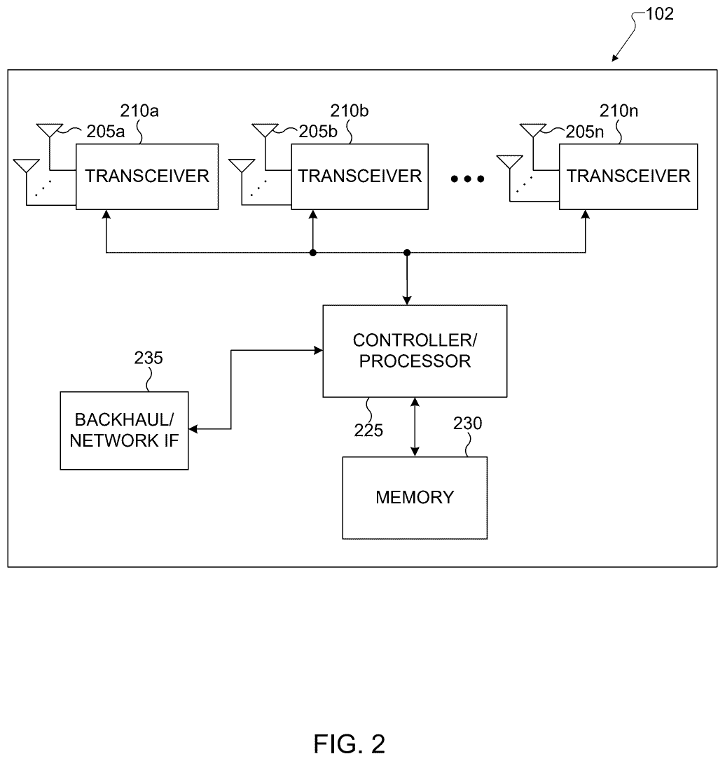

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes for AI aided carrier aggregation in a wireless communication system as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

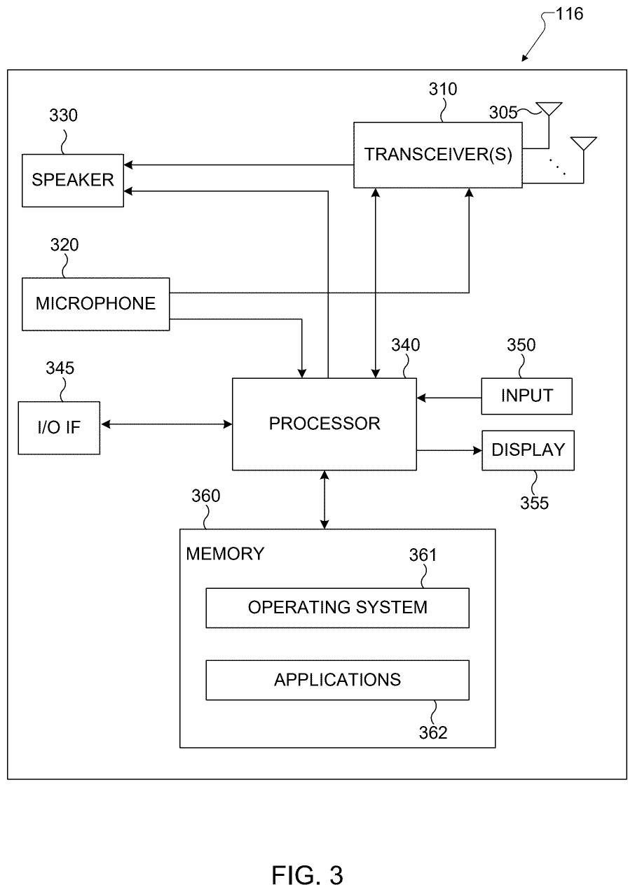

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to provide data for AI-aided carrier aggregation in a wireless communication system as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

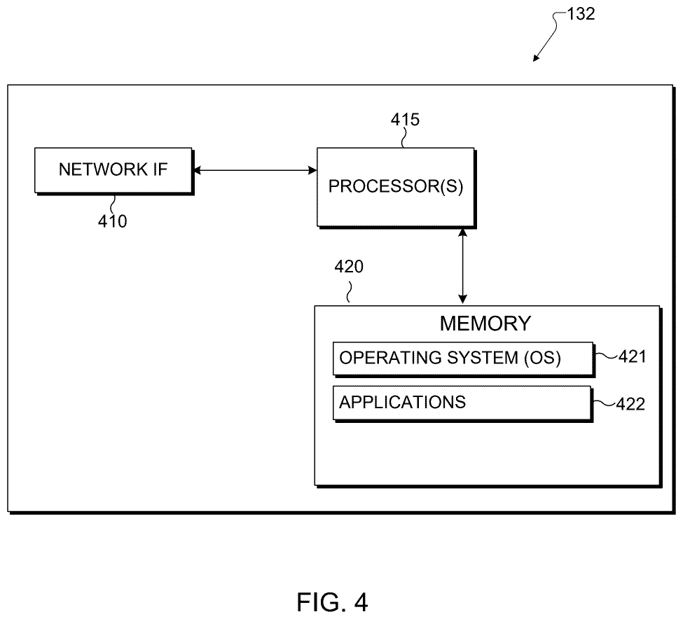

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103 and or any other appropriate sources. For example, the server 132 may receive data including channel state information (CSI) of a primary component carrier (CC) for training an AI model configured to determine CSI of a secondary CC (hereinafter, also referred to as a secondary cell or SCell) based on the CSI of the primary CC (hereinafter, also referred to as a primary cell or PCell) received from a UE. Once the AI model is trained, it may be deployed to one or more gNBs 101-103 for AI-aided carrier aggregation and signal prediction.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as the AI model as well as a CPU, a GPU or a tensor processing unit (TPU) that provides significant computational resources required for training the AI model.

The processor 415 is also capable of executing other processes and programs resident in the memory 420, such as operations that receive and store data. As described in greater detail below, the processor 415 may execute processes to perform offline training of the AI model to predict CSI of an SCell based on CSI of a PCell received from one or more UEs 111-116. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include training data for offline training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like. Further, the AI model may be trained at a separate AI workstation(s) or cloud environment dedicated to train the AI model.

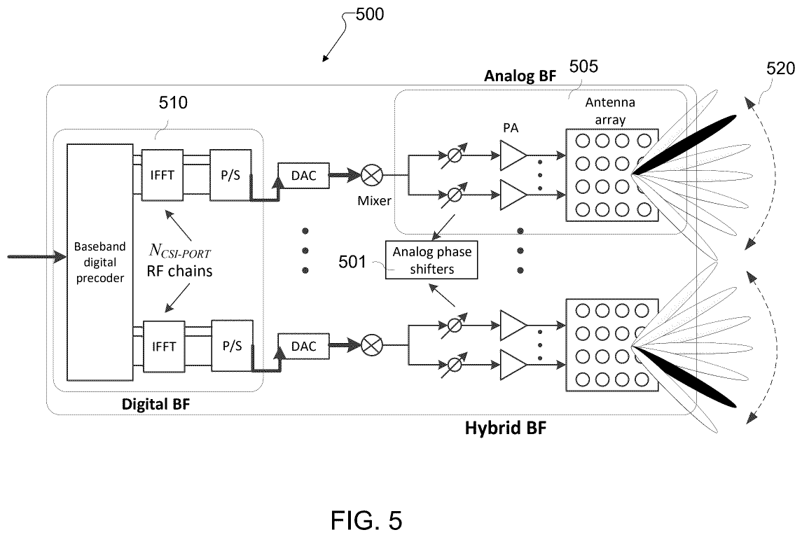

FIG. 5 illustrates example antenna blocks or arrays 500 according to embodiments of the present disclosure. The embodiment of the antenna blocks or arrays 500 illustrated in FIG. 5 is for illustration only. Different embodiments of antenna blocks or arrays 500 could be used without departing from the scope of this disclosure.

A unit for downlink (DL) signaling or for uplink (UL) signaling on a cell is referred to as a slot and may include one or more symbols. A bandwidth (BW) unit is referred to as a resource block (RB). One RB includes a number of sub-carriers (SCs). For example, a slot may have duration of one millisecond and an RB may have a bandwidth of 180 kHz and include 12 SCs with inter-SC spacing of 15 KHz. A slot may be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH may be transmitted over a variable number of slot symbols including one slot symbol. A UE may be indicated a spatial setting for a PDCCH reception based on a configuration of a value for a transmission configuration indication state (TCI state) of a control resource set (CORESET) where the UE receives the PDCCH. The UE may be indicated by a spatial setting for a PDSCH reception based on a configuration by higher layers or based on activation or indication by MAC CE or based on an indication by a DCI format scheduling the PDSCH reception of a value for a TCI state. The gNB may configure the UE to receive signals on a cell within a DL bandwidth part (BWP) of the cell DL BW.

A gNB (such as BS 103 of FIG. 1) transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116 of FIG. 1) may determine CSI-RS transmission parameters through DL control signaling or higher layer signaling, such as an RRC signaling from a gNB. Transmission instances of a CSI-RS may be indicated by DL control signaling or configured by higher layer signaling. A DMRS is transmitted only in the BW of a respective PDCCH or PDSCH and a UE may use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH may be transmitted over a variable number of slot symbols including one slot symbol. The gNB may configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information may be configured to be with a smaller granularity than per TB and may be per data code block (CB) or per group of data CBs where a data TB includes a number of data.

A CSI report from a UE may include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB may use a DMRS to demodulate information in a respective PUSCH or PUCCH. SRS is transmitted by a UE to provide a gNB with an UL CSI and, for a TDD system, an SRS transmission may also provide a PMI for DL transmission. Additionally, in order to establish synchronization or an initial higher layer connection with a gNB, a UE may transmit a physical random-access channel (PRACH).

Each of these discussed transmitted, received, and/or calculated parameters or metrics are examples of data that is generated at the base station and/or UE that may be utilized in the AI-aided carrier aggregation in wireless communication systems in various embodiments of the present disclosure.

Although FIG. 5 illustrates one example antenna blocks or arrays 500, various changes may be made to FIG. 5. For example, various components in FIG. 5 could be combined, further subdivided, or omitted and additional components could be added according to particular needs.

In modern wireless systems, such as those described regarding FIGS. 1-5, numerous technologies have been developed to meet the demand for wireless data traffic. Carrier Aggregation (CA) is one of such technologies and has played an essential role in satisfying and enhancing the throughput (Tput) demands. In the CA, a UE-assigned bandwidth may be expanded by adding new component carriers (CCs). A UE is served by a serving cell. The cell that handles radio resource control (RRC) signaling is a primary serving cell (also referred to herein as a PCell or a primary CC), and other cells are referred to as secondary cells (also referred to herein as secondary CCs or SCells). To achieve a high Tput in massive MIMO systems, a base station relies on reference signals such as sounding reference signals (SRSs) transmitted by a UE(s) to the wireless network. For the CA, channel state information (CSI) in both of the PCell and the SCell(s) is needed. However, due to the overhead limitations and current commercial implementations, CSI may be available in the PCell only.

For example, transmitting the SRSs in all of the CCs may be difficult due to the significant overhead required for transmitting the SRSs on the SCell(s) and/or the lack of the capabilities of the existing UEs to support transmission of the SRSs on multiple CCs. To acquire CSI in an SCell(s), the existing systems rely on coarse channel feedback (e.g., without limitation, Wideband PMI type 1) to guide the precoding. However, such solution remains rough and results in a significant Tput loss. Further, aside from its utility for the high Tput in the MIMO systems, the knowledge of the CSI in both of the CCs may be useful in many applications, e.g., without limitations, resource allocations.

The present disclosure provides methods and apparatuses for AI-aided CA in wireless communication systems, in particular for predicting CSI in an SCell using CSI of a PCell in massive MIMO systems. By predicting CSI of an SCell based on a received CSI of a PCell, the embodiments of the present disclosure not only improve the overall Tput, but also eliminate the need for SCell signaling. Further, the embodiments of the present disclosure allow proper SCell assignment, resource allocation, precoding, beamforming, scheduling and/or grouping of UEs based on the predicted SCell CSI, thereby significantly improving efficiency and reliability of the operations of massive MIMO systems.

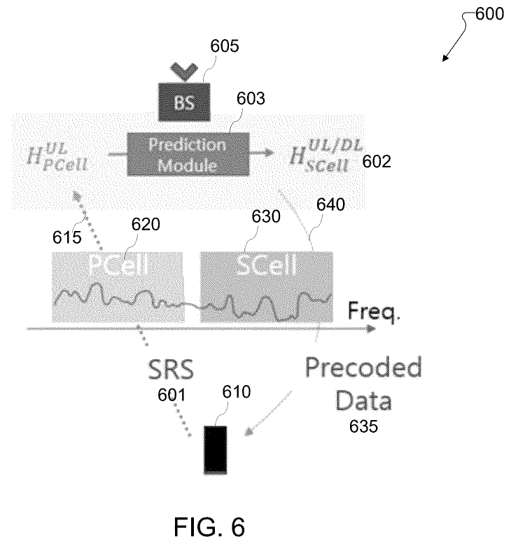

FIGS. 6-19 illustrate various embodiments of the apparatuses and methods of AI-aided signal prediction and/or components and features thereof. While the embodiments as illustrated in FIGS. 6-19 describe the signal prediction apparatuses and methods applied at the base station side, these apparatuses and methods may be applied at either the base station side or the UE side. Further, while the embodiments as illustrated in FIGS. 6-19 illustrate signal prediction apparatuses and methods for CA with one CC (SCell) for the sake of clarity, the apparatuses and methods may be applied to CA with multiple CCs (SCells) as appropriate without departing from the scope of the present disclosure. In addition, the apparatuses and methods according to the present disclosure may also be applied for time division duplex (TDD) and/or frequency division duplex (FDD) systems.

FIG. 6 illustrates a diagram of an example signal prediction process 600 in a wireless communication system according to embodiments of the present disclosure. The embodiment of the signal prediction process 600 in FIG. 6 is for illustration only. Other embodiments of a signal prediction process may be used without departing from the scope of this disclosure. While FIG. 6 illustrates a signal prediction process based on an SRS received from a UE via a PCell, it is for illustrative purposes only, and thus any other appropriate reference signals (pilots) may be utilized to predict channel state information (CSI) of an SCell without departing from the scope of the present disclosure.

In the example of FIG. 6, a UE 610 may transmit to a base station 605 an SRS 601 in an unlink (UL) channel 615 in a PCell 620. The base station 605 may be any of gNBs 101-103 as illustrated in FIGS. 1 and 2, and the UE 610 may be any of UEs 111-116 as illustrated in FIGS. 1 and 3. CSI of the PCell 620 may be inferred from the received SRS 601. As such, the base station 605 may input the SRS 601 (i.e., the CSI of the PCell 620) to a signal predicting model 603 for predicting CSI 602 of an SCell 630 for the UE 610.

The signal predicting model 603 may an artificial intelligence (AI) model including a plurality of appropriate neural networks and hosted within the base station 605. The signal predicting model 603 may predict the CSI of the SCell 630 based on the CSI (e.g., without limitation, the SRS 601) of the PCell 620. The signal predicting model 603 may then output the predicted CSI 602 of the SCell 630, and the base station 605 may utilize the CSI 602 of the SCell 630 for various applications, for example and without limitation, precoding a DL transmission 635 via a DL channel 640 in the SCell 630.

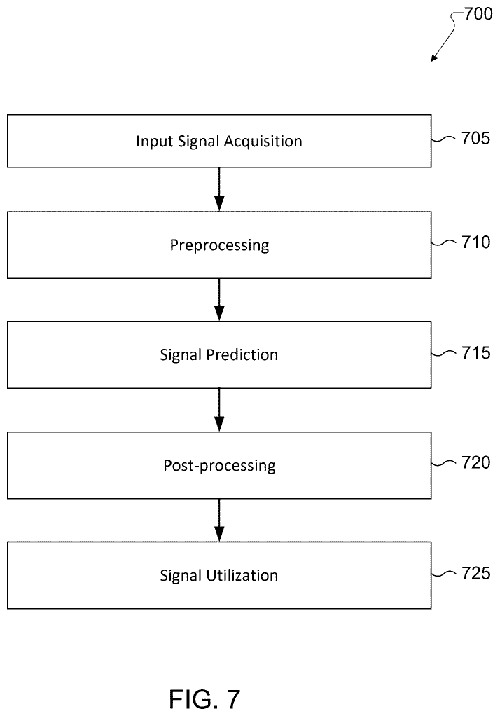

FIG. 7 illustrates a flow chart of an example signal prediction method 700 according to embodiments of the present disclosure. As illustrated in the example of FIG. 7, the method 700 begins at step 705. At step 705, a base station acquires an input signal in a PCell through an explicit signaling (e.g., without limitation, an SRS signaling, a PMI type-2 feedback) or other appropriate means (e.g., without limitation, a data aided estimate). The input signal may pass through a signal processing such as a channel estimation or a synchronization. The acquired input signal at step 705 may be a received signal in the PCell for all or subset of resource elements or resource blocks in the entirety or a portion of the PCell bandwidth for all or a subset of antenna ports.

At step 710, the input signal may undergo preprocessing for a subsequent signal prediction. The preprocessing may include, for example and without limitation, normalization and transformation. At step 715, the preprocessed input signal may pass through a signal predicting model, which is configured to predict a signal and output the predicted signal. The output signal at step 715 may be the corresponding signal in the SCell bandwidth for one or more CCs.

In one embodiment, an SRS signal in a PCell for all of the antenna ports may be used to predict DL (or UL) RB level channel coefficients in the SCell bandwidth for all of the antenna ports. In another embodiment, a sub-band PMI in a PCell may be used to predict a sub-band PMI (or the CSI) in an SCell. In these two embodiments, a sub-sampled (missing) RBs, sub-band or antenna ports, or a linear/non-linear combination thereof may also be handled.

The signal predicting model may use one or more sub-models (sub-modules) to predict CSI of an SCell. For example, a classifier may be followed by a channel predictor f_{θ}(.), where f is a channel prediction function, and θ is one or more set of tunable parameters. After the channel (or signal) prediction, the base station may use the predicted signal as a final output of the signal predicting model. In some example embodiments, the signal predicting model may perform one or more other functionalities:
1) adjust or calculate a precoder for one or more UE devices, e.g., using ZF, (L-) MMSE based methods, or codebook selection;
2) adjust or calculate analog beamforming weights, e.g., beam-selection from a predefined codebook;
3) select, group or schedule one or more UEs; or
4) execute resource allocation, e.g., CA decisions or power allocation per resource.

A precorder and/or beamforming design may include a maximum ratio transmission (MRT) or covariance for single user (SU) MIMO systems, or zero forcing (ZF) or minimum mean square error (MMSE) for multi-user (MU) MIMO systems.

At step 720, the predicted signal may undergo post-processing. The post-processing may include, for example and without limitation, de-transformation or scaling of the predicted signal.

At step 725, the post-processed predicted signal may be utilized in one or more CA tasks such as resource allocation, scheduling, precoding and beamforming, and so forth.

In one embodiment, the method 700 may include employing signal normalization techniques to stabilize the performance of the signal prediction module. In one embodiment, the method 700 may include filtering or clustering to eliminate the impact of any outliers. In one embodiment, the method 700 may include utilizing prediction in transformed domains. For example and without limitation, the input signal H_{PCell} of the PCell is inputted into the signal predicting model, which in turn outputs the predicted signal denoted as Ĥ_{SCell}=fθ(T{H_{PCell}}), where T {.} is a transformation function, f is a channel prediction function, and θ is one or more set of tunable parameters. The predicted signal Ĥ_{SCell} may belong to the same or a different domain as T{H_{PCell}}.

In one embodiment, the T{.} may be a DFT. Assume that the received signal in the PCell is H_{PCell} of size Nₜ×Nᵣ×N_{f}, where Nₜ is the number of antennas at the base station side, Nᵣ is the number of antennas at the UE side, and N_{f} is the number of frequency samples, e.g., the

RB level. The prediction may then be applied to, for example and without limitation:
Frequency antenna domain H_{PCell}, i.e., no transformation is used;
Delay antenna domain F_{1D}{H_{PCell}}, where F_{1D} is a DFT transformation (here applied to frequency);
Delay angle domain F_{2D}{H_{PCell}}, where F_{2D} is 2D DFT, applied here to frequency and BS antennas; or
Frequency angle domain F_{1D}{H_{PCell}}, where F_{1D} is applied to BS antenna. Other combinations may be also possible.

Throughout these steps 705-725, the input signal and/or the predicted signal may be stored in an appropriated buffer(s). For instance, after step 705, the input signal may be stored temporarily in a buffer before it is preprocessed, and the buffer may be shared or separate for each step.

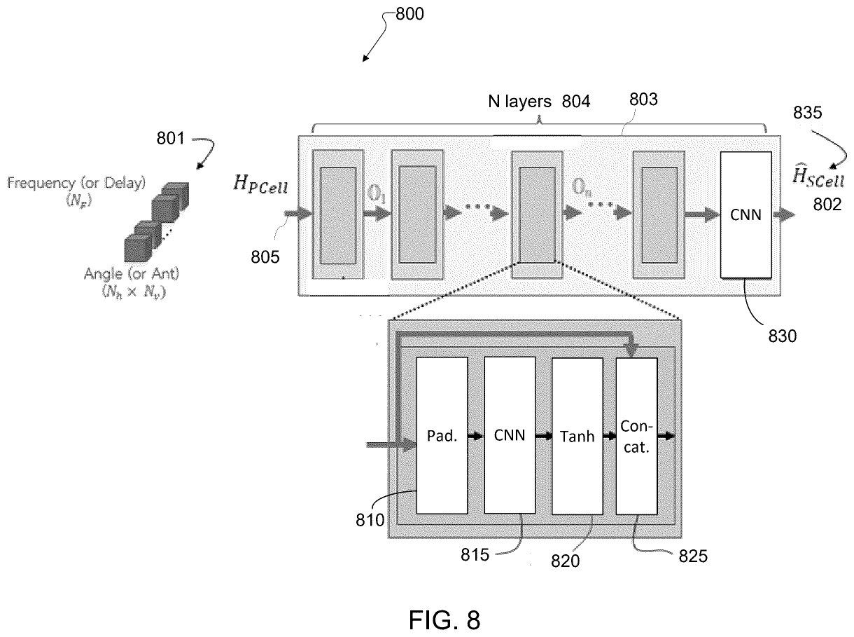

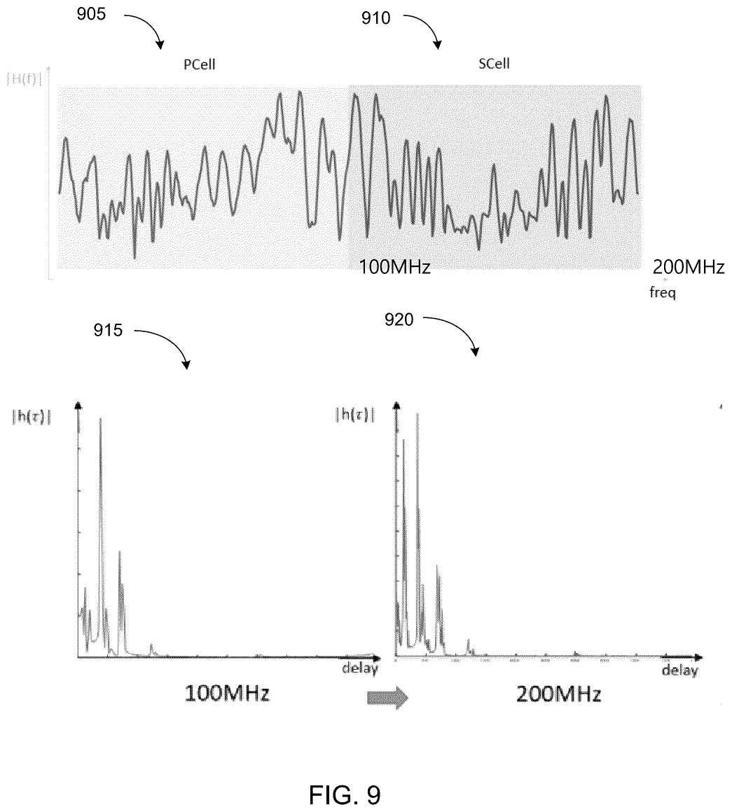

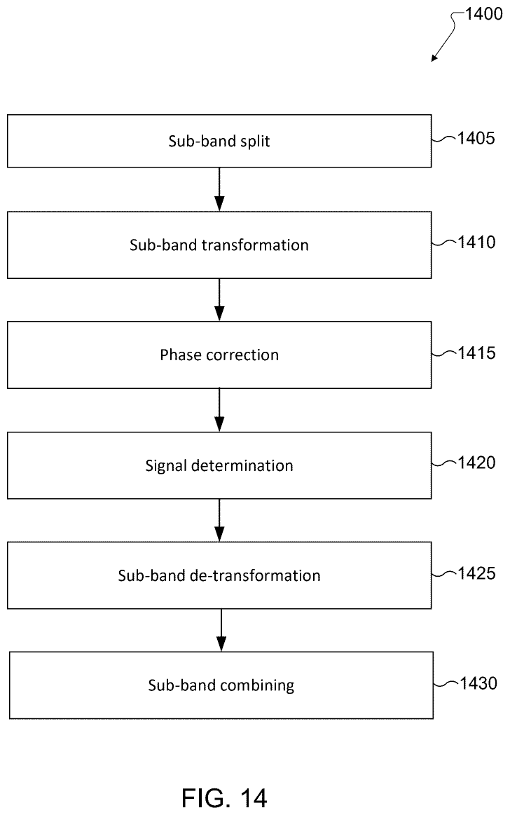

The signal prediction method 700 may include a direct signal prediction method (as illustrated in FIG. 8), a super-resolution algorithm based signal prediction method (as illustrated in FIGS. 9-13), and a sub-band based sequential signal prediction method (as illustrated in FIGS. 14-16). However, these are for illustrative purposes only, and thus any other appropriate signal prediction method may be applied without departing from the scope of the present disclosure.

FIG. 8 illustrates a flow diagram of an example direct signal prediction method 800 performed by a signal predicting model 803 according to embodiments of the present disclosure. The signal predicting model 803 may have a convolutional neural network (CNN) based structure, which shows performance gains. The signal predicting model 803 may have n layers 804. The layers 804 may be based on, e.g., a complex-valued CNN architecture. As illustrated in the example of FIG. 8, the direct signal prediction method 800 begins at step 805.

At step 805, a signal predicting model 803 receives an input signal (i.e., CSI of a PCell H_{PCell}) 801, which may be of any data format. In the example of FIG. 8, the input signal 801 may be a frequency (or delay) that constitutes a channel of a CNN. It may be an angle (or antenna) 2D images (for planar arrays). Each layer 804 may then add padding to the input signal at step 810, apply convolution (e.g., filtering) to padded input signal at step 815, execute an activation function (e.g., without limitation, a hyperbolic tangent (Tanh)) at step 820, and add a skip connection through concatenation at step 825 to present the signal to all of the n layers 804. At step 830, the signal predicting model 803 may utilize a linear CNN layer to combine the features and predict a signal. At 835, the signal predicting model 803 may output the predicted signal (i.e., CSI of an SCell Ĥ_{SCell}) 802.

In one embodiment, the direct signal prediction may be applied in the frequency domain, i.e., the de-transformation is applied before the prediction. In one embodiment, after one or more steps in FIG. 8, an additional scaling(s) may be applied.

FIGS. 9-13 illustrate a super-resolution algorithm based signal prediction method and associated algorithm and images according to embodiments of the present disclosure. In this method, an SCell prediction may be viewed as a PCell enhancement. That is, the PCell may provide a rough low-resolution signal structure while the combined PCell and SCell may represent a high-resolution structure. To achieve the higher resolution signal structure, at least a transformation in the delay domain of the PCell may be performed. In the delay domain, the PCell signal may be viewed as a low resolution image of the combined PCell and SCell. Thus, the PCell (the low resolution image) and the combined {PCell, SCell} may be viewed as a training pair.

FIG. 9 illustrates an example carrier aggregation based on the super-resolution algorithm based signal prediction method according to embodiments of the present disclosure. As illustrated in the example of FIG. 9, CSI 905 of a PCell having a bandwidth of, e.g., 100 MHz may be received from a UE. CSI 910 of an SCell having the same bandwidth, however, may not yet be received, and thus unknown to the base station. The method 900 may then utilize the super-resolution algorithm to predict the CSI 910 of the SCell. To predict the CSI 910 of the SCell, the received CSI 905 of the PCell may be transformed into a delay domain and the transformed CSI 915 may now provide a low resolution image. The low resolution image may be passed through the super-resolution algorithm and a higher resolution image 920 combining the PCell and SCell may be output.

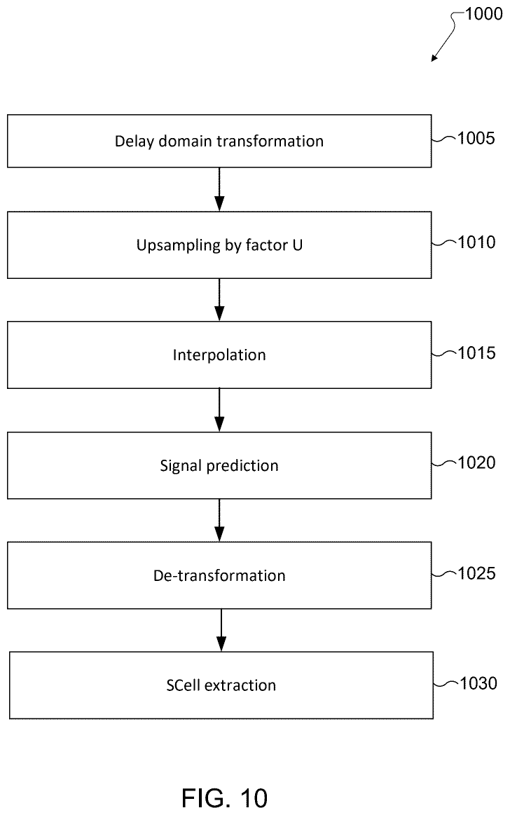

FIG. 10 illustrates a flow chart of the super-resolution algorithm based signal prediction method 1000 according to embodiments of the present disclosure. As illustrated in FIG. 10, the method 1000 begins at step 1005.

At step 1005, the base station (e.g., without limitation, a controller/processor 225 as described with reference to FIG. 2) may transform the input signal (CSI of the PCell) into a delay domain. It is noted that it has been shown that when a transformed PCell is compared to the joint PCell and SCell in the delay domain, different scenarios may occur when including higher frequencies. For example, certain peaks of the PCell may shrink, become shifted or preserved in the joint PCell and SCell.

Optionally, at step 1010, the base station may up-sample the input signal in the delay domain by an up-sampling factor (U). The factor U may be based on the system complexity, but may be also calculated to match the PCell and SCell total bandwidth, e.g., U=ceil(Bandwidth PCell+Bandwidth SCell/Bandwidth PCell). Optionally, at step 1015, the base station may perform interpolation on the input signal. The base station may then feed the input signal to a signal predicting model.

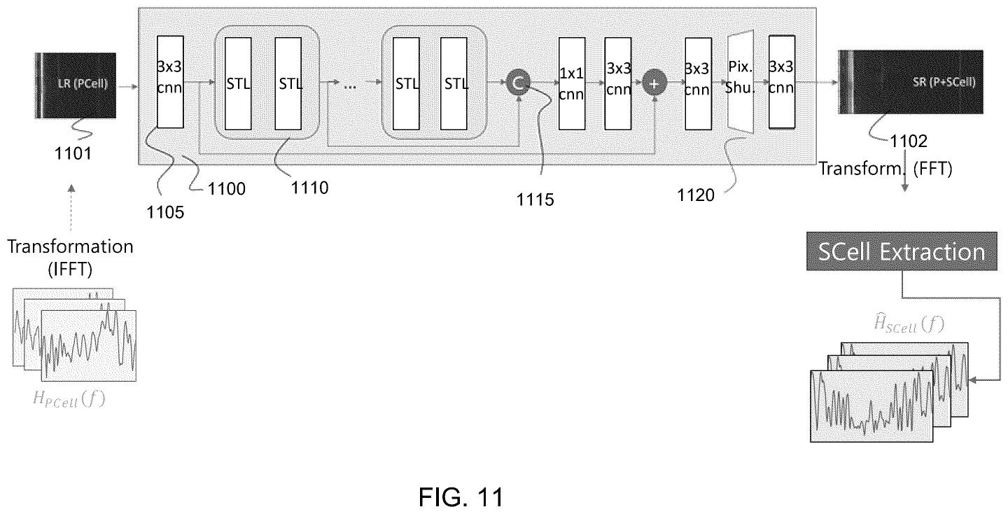

At step 1020, the signal predicting model may predict a signal (CSI of an SCell) based on a resolution algorithm, e.g., without limitation, a super-resolution algorithm. At step 1025, the base station may de-transform the predicted CSI (e.g., back to the frequency domain). At step 1030, the predicted signal (an appropriate port) of the SCell may be extracted in the frequency domain. The signal predicting model may apply any super-resolution technique. An example super-resolution network structure utilized in the super-resolution algorithm based signal prediction method 1000 is discussed in detail with reference to FIG. 11.

FIG. 11 illustrates an example network structure 1100 of a super-resolution algorithm as applied in the method 1000 according to embodiments of the present disclosure. In FIG. 11, the super resolution algorithm utilizes a shifted-window (SWIN) transformer. The super resolution network 1100 includes convolutional layers (also referred to herein as CONV) 1105 and SWIN transformer layers (STLs) 1110.

As illustrated in FIG. 11, received CIS of a PCell may be transformed into a delay domain. The super resolution network may receive a low-resolution image (the PCell in a delay domain) 1101 to produce a super-resolution image (a combination of the PCell and an SCell in the delay domain) 1102. The SCell may be then de-transformed into the frequency domain and extracted for CA applications. The operation of the super resolution network 1100 is now discussed in detail.

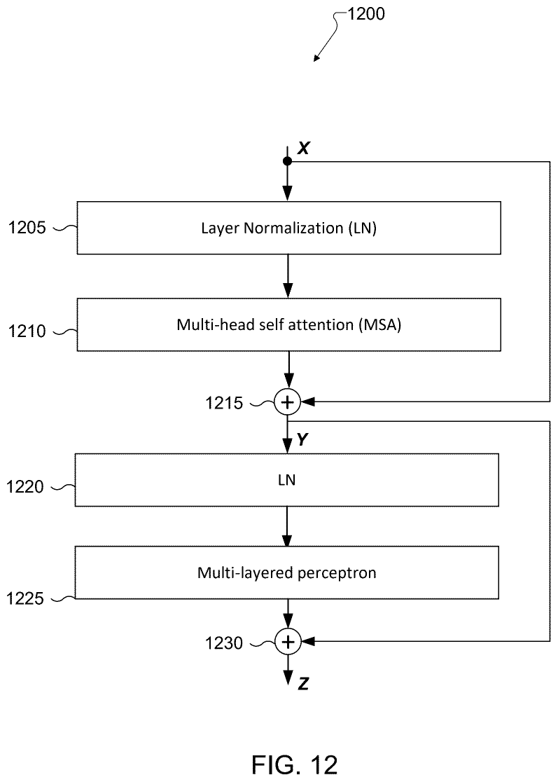

Upon receiving the low-resolution image 1101, a convolution layer (e.g., without limitation, a 3×3 convolution layer) 1105 of the super resolution network 1100 may extract features from the low-resolution image 1101 and output feature maps of the low-resolution image 1101 to a pair of STLs 1110. The STLs 1110 may perform multi-head self-attention (MSA) operations on the feature maps, discussed further in detail with reference to FIG. 12. The output of the pair of the STLs 1110 may then be input to the next pair of the STLs 1110 until all of the STLs 1110 have performed the MSA operations on the respective feature maps. To enhance training of the signal predicting model, the outputs of the pairs of the STLs 1110 may be concatenated 1115, along with a residual (skip) connection. Finally, mapping 1120 to a final image size may be performed with convolutional layers and pixel shuffle operation by reducing the number of channels. The mapping 1120 may be executed by reduction of the number of channels be a 3×3 CONV that reduces the number of channels to a scaling factor x² (e.g., without limitation, 4). The pixel shuffle operation may then follow and reduce the number of channels by the scaling factor x² and increase the image resolution by x in both of the image dimensions (H and W). A final convolution layer may then perform a final image mapping to the final image size.

Alternative operations may be also possible. For example, a pixel-shuffle operation in one dimension may be useful for a delay/frequency domain super-resolution as illustrated herein. Further, with the combination of reshaping and convolution operations, a stride may be used to map to the final image size.

The super resolution network 1100 may then output the high-resolution image (PCell+SCell) 1102. It is noted that the residual connection steps and the resolution increase method based on CNNs, and the pixel shuffle are for illustrative purposes only, and thus any other skip connection or resolution increase mechanisms may be utilized to produce a higher resolution image without departing from the scope of the present disclosure.

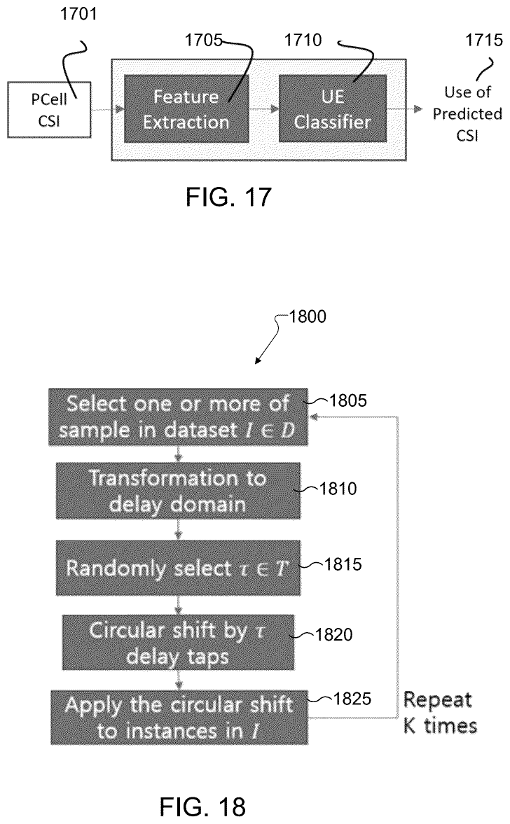

It has been shown that the super-resolution algorithm based signal prediction method 1000 provides a significant gain (>5 dB NMSE) over the existing AI-based channel estimation solutions. Further, it has been shown that this method provides improved and long prediction horizon with UE selection (discussed in detail with reference to FIG. 17).

FIG. 12 illustrates an example flow of multi-head self attention (MSA) algorithm 1200 performed by a SWIN transformers layer (STL) according to embodiments of the present disclosure. As illustrated in FIG. 12, the MSA operation begins at step 1205.

At step 1205, the STL may perform a layer normalization on the input signal (or an input tensor X). At step 1210, the STL may pass the normalized X through the MSA. At step 1215, a residual connection (adding X to the normalized X that has passed through the MSA) may be performed, outputting Y (i.e., Y=MSA(LN (X)+X).

At step 1220, the STL may perform a layer normalization on Y. At step 1225, the STL may then pass the normalized Y through a multi-layer perceptron (MLP). At step 1230, another residual connection (adding Y to the normalized Y that has passed through the MLP) may be performed, outputting Z. Thus, the output for one STL is Z (i.e., Z=MLP(LN(Y)+Y).

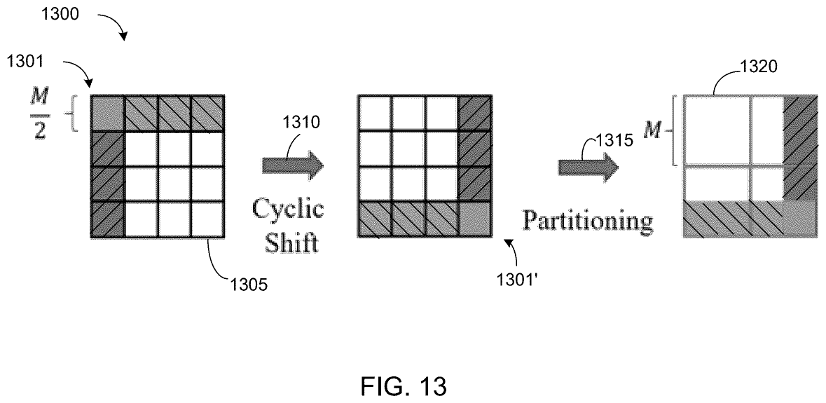

However, unlike the conventional transformer layers, the STL incorporates local attention on a signal and a cyclic shifted version of the signal, as discussed further in detail with reference to FIG. 13.

FIG. 13 illustrates an example flow of a multi-head self attention (MSA) algorithm 1300 being performed on an original signal 1301 and corresponding cyclically shifted signal 1301′ according to embodiments of the present disclosure. As illustrated in FIG. 13, an input signal (e.g., a low-resolution image) may be divided into non-overlapping windows, and a local attention may be applied to the windows in one STL. In the following STL, a cyclic shift may be applied to the signal so that the windows contain part of earlier non-overlapping windows (ports). Thus, a pair of STLs may be used in a SWIN block, which also contains a cyclic shift operation.

The cyclic shift operation is now described in detail. In the embodiment of FIG. 13, it is assumed that the size of an image 1301 is, e.g., without limitation, 2M×2M and the size of the non-overlapping window 1305 is

$$\frac{M}{2} \times \frac{M}{2} .$$

The shifted window partitioning means shifting the feature 1301 by

$$[ \frac{M}{2} , \frac{M}{2} ]$$

pixels before partitioning. There may be two steps 1310, 1315 to the shifted window partitioning. First, at step 1310, the feature 1301 may be cyclically shifted to bottom-right by

$$\frac{M}{2}$$

pixels. Then, at step 1315, the cyclically shifted feature 1301′ may be partitioned to non-overlapping windows 1320 with size M×M. For a shifted window, the whole feature may be cyclically shifted by

$$[ \frac{M}{2} , \frac{M}{2} ]$$

pixels to the bottom-right. After the cyclic shift, the feature may be partitioned to 4 M×M windows. After the MSA is performed, the feature 1301′ is shifted back using a

$$[ - \frac{M}{2} , - \frac{M}{2} ]$$

cyclic shift.

FIG. 14 illustrates an example sub-band based sequential signal prediction method 1400 according to embodiments of the present disclosure. In the signal prediction method 1400, a signal predicting model may predict a signal (an SCell CSI) based on a sequential prediction over sub-bands.

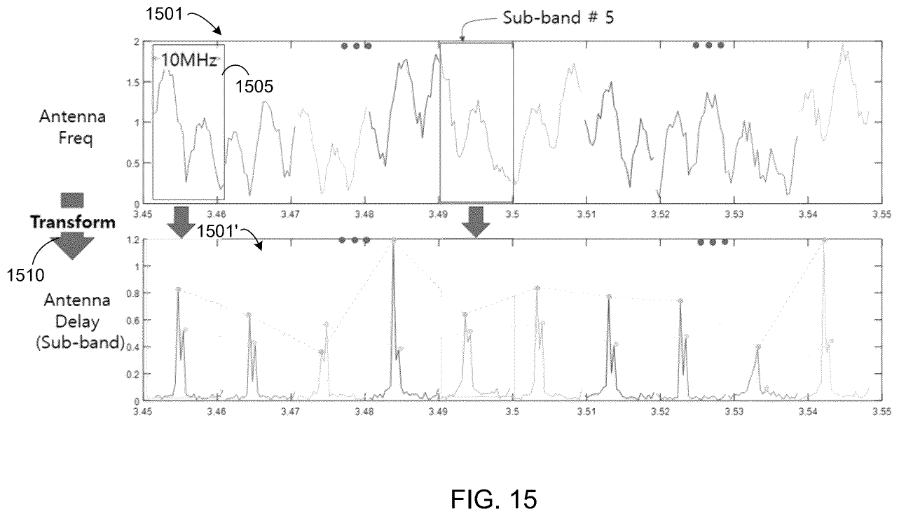

As illustrated in FIG. 14, the signal prediction method 1400 begins at step 1405. At step 1405, the signal predicting model may split the frequency band of an input signal (a PCell CSI) into L sub-bands. The choice of L may be based on a number of factors such as a model complexity, a coherence bandwidth, or limitations with the system or hardware. At step 1410, the signal predicting model may apply to the input signal in sub-bands a transformation into a delay domain or other appropriate transformation such as an angle delay domain and so forth. For example, and without limitation, a sub-band split of 10 MHz may be applied to the PCell signal of a 100 MHz total bandwidth, i.e., L=10, as shown in FIG. 15.

At step 1415, the signal predicting model may perform a phase correction such that the strongest peak of the transformed signal is prioritized. For clarity, let H_{PCell}∈C^{N}^{ₜ}×^{N}^{_{f}}, i.e., one UE antenna. The phase correction may be performed as follows:

$${H}_{PCell} = [ {H}_{1} , … , {H}_{L} ]$$

Next, let the transformed signal in a sub-band i be Gᵢ=T{Hᵢ},

$${G}_{PCell} = [ {G}_{1} , … , {G}_{L} ]$$

The phase correction may be achieved by:

$${G}_{i} = {α}_{i}^{H} {G}_{i} , ∀ i$$

where αᵢ is a scaler, and k and n are indices for an antenna (or angle) and delay, respectively. The scaler αᵢ may be calculated as follows:

$${α}_{i} = \frac{{G}_{i} ( {k}^{*} , {n}^{*} )}{\vert {G}_{i} ( {k}^{*} , {n}^{*} ) \vert}$$

The indices k and n may be found as follows:

$${k}^{*} = arg {max}_{k} {\sum }_{i} {\sum }_{n} {\vert {G}_{i} ( k , n ) \vert}^{2} , k ∈ \{ 1 , … , \frac{{N}_{f}}{L} \} , n ∈ \{ 1 , … , {N}_{t} \}$$

$${n}^{*} = arg {max}_{n} {\sum }_{i} {\vert {G}_{i} ( k , {n}^{*} ) \vert}^{2}$$

At step 1420, the normalized and mapped signal may be fed to the signal predicting model, which may be based on, e.g., without limitation, a linear prediction or neural network (NN) architecture such as a recurrent NN based and/or CNN based architecture. The model may exploit residual or skip connections. An example network structure utilizing a CNN structure with a residual connection is illustrated in FIG. 15. At step 1425, the signal in each sub-band may be de-transformed. At step 1430, the sub-bands may be combined.

FIG. 15 illustrates an example sub-band split under the sub-band based sequential signal prediction according to embodiments of the disclosed concept. In FIG. 15, a received CSI 1501 of a PCell with a total bandwidth of 100 MHz has been split into ten 10 MHz sub-bands 1505. The signal 1501 is then transformed 1510 into a delay domain per sub-band 1515. The transformed signal 1501′ in each sub-band may then be utilized to sequentially predict CSI of an Scell.

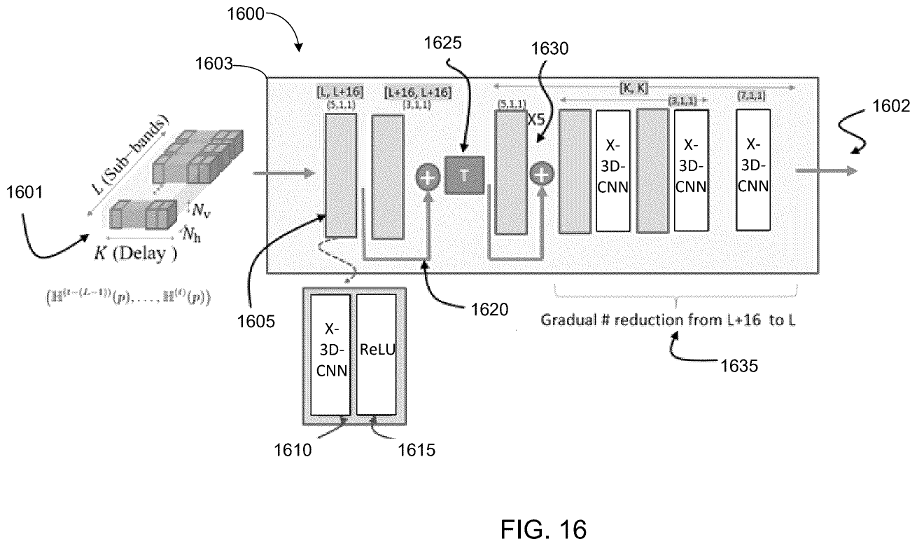

FIG. 16 illustrates an example network structure of a signal predicting model 1600 configured to perform the sub-band based sequential signal prediction method 1400 according to embodiments of the present disclosure. The input 1601 to the signal predicting model 1600 may be L sub-bands, each sub-band having K delay bins (frequency points before the transformation). The signal predicting model 1600 may take an angle or antenna domain. It may be based on a CNN, e.g., a complex valued 3D CNN (X-3D-CNN). In a given layer (e.g., a layer 1605), a CNN 1610 may be followed by an activation function, e.g., ReLU 1615 or any other appropriate activation functions without departing from the scope of the present disclosure. The CNN 1610 may apply an expansion to the number of channels. As illustrated in FIG. 16, each layer 1605 has increased from L to L+16. A residual layer 1620 may be then utilized. The delay and sub-bands may be then swapped 1625, thereby advantageously reducing the number of parameters in the network. The swapping may thus depend on the number of expanded channels and K. Next, multiple residual layers 1630 may be utilized. The expanded layers 1605 may then be reduced with an appropriate kernel size (e.g., from L+16 to L). The signal predicting model 1603 may then output a predicted CSI 1602 of an SCell. The output signal (the predicted transformed SCell CSI) may need to be de-transformed and concatenated.

FIG. 17 illustrates an example UE selection mechanism 1700 according to embodiments of the present disclosure. As previously mentioned, transmitting sounding signals in a secondary component carrier (CC) incurs a significant overhead and the existing UEs do not have the capability to transmit CSI in all of component carriers (CC). As a result, collecting the CSI in the SCell is challenging, and thus a number of datapoints that have multiple CC pairs is limited. Further, it has been shown that a diversity of datapoints in a training dataset impacts the quality of the SCell CSI prediction. The UE selection mechanism 1700 resolves these problems and challenges by providing a simple mechanism to determine whether a CSI prediction of an SCell for a UE is feasible.

In one embodiment, simplified features may be used as an input to a simple classifier model, e.g., a random-forest or simple rule for low dimensional features. The classifier may then perform classification and determine whether a CSI prediction of an SCell for a UE is feasible or reliable.

As illustrated in FIG. 17, a received CSI 1701 of a PCell is input to a feature extraction module 1705. The feature extraction module 1705 may extract one or more of a power delay profile (PDP), a PDP correlation with training dataset, a delay spread, an antenna correlation, a K-factor, or any other appropriate statistical features of the PCell CSI 1701. The K-factor is a Rician fading factor, where K is the ratio between the power in the line-of-sight path and the power in the non- line-of-sight paths. The one or more extracted features may then be fed to a UE classifier 1710, which is configured to determine whether a CSI prediction of an SCell is reliable. If it is determined that the CSI prediction is reliable, then the predicted CSI may be utilized 1715 for, e.g., resource allocation, scheduling, precoding and beamforming, or any other appropriate CA applications.

If it is determined that the CSI prediction is not reliable, other solutions (e.g., without limitation, a PMI for precoding) may be utilized. Further, the classifier 1705 may be trained off-line. For example, it has been shown that when a PDP correlation between a training dataset and a test point is small, the CSI prediction may fail with a high probability. Thus, in one embodiment, a small number of representative PDPs (or only their statistics) from the training dataset may be stored, and during the online process, the correlation to the representative PDP may be calculated with the maximum correlation being compared to a predefined threshold (based on an offline tuning). In another embodiment, an AI model may be used to predict the correlation value, and a threshold can be used to classify the UEs. In yet another embodiment, the aforementioned features and/or other features may be used to cluster the datapoints in the training dataset. During testing, datapoints that seem to be outliers may not be selected.

FIG. 18 illustrates an example training enhancement method 1800 according to embodiments of the present disclosure. Due to the aforementioned challenges in collecting large datasets for the CA, it is necessary to utilize the collected data efficiently. Thus, the training enhancement method 1800 provides augmentation of the collected data for tuning and training enhancement, thereby significantly improving the signal prediction robustness to various channels and UE capabilities. The collected data may be augmented or enhanced based on, for example and without limitation, noise addition, phase perturbations or delay circular shifts. For an instant i in the dataset, the noise addition and phase perturbations may be written as:

$${H}_{PCell , i} = {H}_{PCell , i} {e}^{j {θ}_{i}} + {N}_{i}$$

$${H}_{SCell , i} = {H}_{SCell , i} {e}^{j {θ}_{i}}$$

where Nᵢ is a noise realization added to a PCell. Furthermore, the phase of complex numbers is shifted by θᵢ˜U[−π·π].

For a given signal in a delay domain, a circular shift of the signal with τ taps may also be used as a variation of the signal as illustrated in FIG. 18. As shown in FIG. 18, the circular shift training enhancement method begins at step 1805. At step 1805, one or more samples in dataset I∈D may be selected. At step 1810, the one or more samples may be transformed into a delay domain. At step 1815, a delay tap τ∈D may be selected. At step 1820, the one or more samples may be circular shifted by τ delay taps. At step 1825, the circular shift may be applied to the instances in I, and the method 1800 returns to step 1805 and is repeated.

It is noted that the method 1800 may also be applied in the frequency domain with transformation and inverse transformation. Alternatively, the method 1800 may apply an equivalent to a circular shift in the frequency domain.

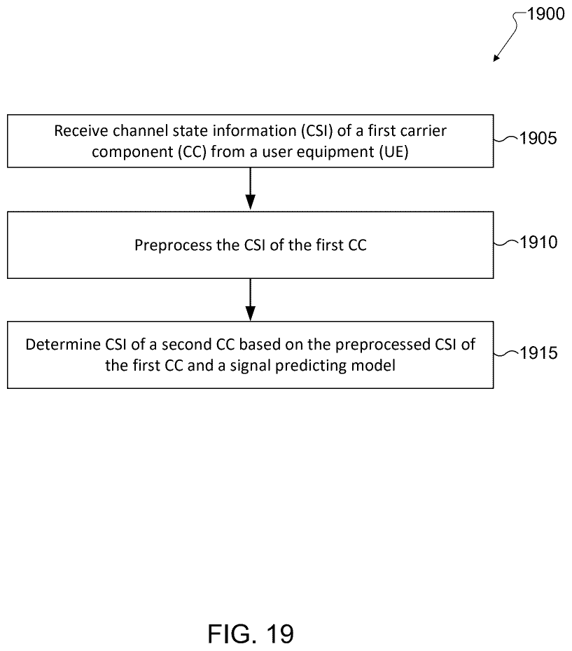

FIG. 19 illustrates an example flow chart for a method 1900 for Artificial Intelligence (AI)-aided carrier aggregation (CA) in wireless communication systems according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of CA could be used without departing from the scope of this disclosure.

As illustrated in FIG. 19, the method 1900 begins at step 1905. At step 1905, an electronic device (e.g., without limitation, a base station 101-103 of FIGS. 1 and 2) may receive channel state information (CSI) of a first carrier component (CC) from a user equipment (UE).

At step 1910, the electronic device may preprocess the CSI of the first CC.

At step 1915, the electronic device may determine CSI of a second CC based on the preprocessed CSI of the first CC and a signal predicting model. In one embodiment, determining the CSI of the second CC may include transforming the CSI of the first CC to a low resolution image in delay domain; applying a super-resolution algorithm to the low resolution image; and producing a higher resolution image based on the super-resolution algorithm and the low resolution image, the higher resolution image including the CSI of the first CC and the CSI of the second CC. In another embodiment, determining the CSI of the second CC may include: transforming the CSI of the first CC to a low resolution image in delay domain; applying a super-resolution algorithm to the low resolution image based on a shifted windows (SWIN) transformer, where the signal predicting model is configured to: divide the low resolution image into non-overlapping windows in a SWIN transformer layer (STL), perform multi-head self attention (MSA) on pairs of STLs, first STL of each pair receiving the MSA and second STL of each pair receiving the MSA on cyclically shifted windows, concatenate outputs of the STLs, and perform final image mapping based on the outputs of the STLs; and producing a higher resolution image based on the final image mapping, the higher resolution image including the CSI of the first CC and the CSI of the second CC.

In one embodiment, where the UE is one of a plurality of UEs, the method 1900 may further include obtaining a feature from CSI of a respective first CC, the feature including a power delay profile (PDP), a PDP correlation, a delay spread, an antenna correlation, or a Rician fading factor; inputting the feature into a classifier; determining that a CSI determination of a respective second CC is reliable based on an output from the classifier; and selecting a UE, from the plurality of UEs, associated with the reliable CSI determination for the second CC. The Rician fading factor herein is a K-factor, where K is the ratio between the power in the line-of-sight path and the power in the non-line-of-sight path.

In one embodiment, the method 1900 may further include: training the signal predicting model based on dataset that has been improved by at least one of noise addition, phase perturbations, or delay circular shifts.

In one embodiment, the method 1900 may further include: splitting the first CC into sub-bands; transforming the CSI in each sub-band into a delay domain; performing phase correction on the transformed CSI; and inputting the phase corrected CSI to the signal predicting model.

In one embodiment, the method 1900 may further include: utilizing the CSI of the second CC for applications including precoder design, scheduling, or resource allocation.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A computer-implemented method comprising:
receiving, at an electronic device, channel state information (CSI) of a first carrier component (CC) from a user equipment (UE);
preprocessing the CSI of the first CC; and
determining CSI of a second CC based on the preprocessed CSI of the first CC and a signal predicting model.

2. The method of claim 1, wherein determining the CSI of the second CC comprises:
transforming the CSI of the first CC to a low resolution image in delay domain;
applying a super-resolution algorithm to the low resolution image; and
producing a higher resolution image based on the super-resolution algorithm and the low resolution image, the higher resolution image including the CSI of the first CC and the CSI of the second CC.

3. The method of claim 1, determining the CSI of the second CC comprises:
transforming the CSI of the first CC to a low resolution image in delay domain:
applying a super-resolution algorithm to the low resolution image based on a shifted windows (SWIN) transformer, wherein the signal predicting model is configured to: divide the low resolution image into non-overlapping windows in a SWIN transformer layer (STL), perform multi-head self attention (MSA) on pairs of STLs, first STL of each pair receiving the MSA and second STL of each pair receiving the MSA on cyclically shifted windows, concatenate outputs of the STLs, and perform final image mapping based on the outputs of the STLs; and
producing a higher resolution image based on the final image mapping, the higher resolution image including the CSI of the first CC and the CSI of the second CC.

4. The method of claim 1, wherein the UE is one of a plurality of UEs and the method further comprises:
obtaining a feature from CSI of a respective first CC, the feature including a power delay profile (PDP), a PDP correlation, a delay spread, an antenna correlation, or a Rician fading factor;
inputting the feature into a classifier;
determining that a CSI determination of a respective second CC is reliable based on an output from the classifier; and
selecting a UE, from the plurality of UEs, associated with the reliable CSI determination for the second CC.

5. The method of claim 1, further comprising:
training the signal predicting model based on dataset that has been improved by at least one of noise addition, phase perturbations, or delay circular shifts.

6. The method of claim 1, further comprising:
splitting the first CC into sub-bands;
transforming the CSI in each sub-band into a delay domain;
performing phase correction on the transformed CSI; and
inputting the phase corrected CSI to the signal predicting model.

7. The method of claim 1, further comprising utilizing the CSI of the second CC for applications including precoder design, scheduling, or resource allocation.

8. An electronic device comprising:
memory; and
a processor operably coupled to the memory, the processor configured to:
receive channel state information (CSI) of a first carrier component (CC) from a user equipment (UE);
preprocess the CSI of the first CC; and
determine CSI of a second CC based on the preprocessed CSI of the first CC and a signal predicting model.

9. The electronic device of claim 8, wherein to determine the CSI of the second CC, the processor is further configured to:
transform the CSI of the first CC to a low resolution image in delay domain;
apply a super-resolution algorithm to the low resolution image; and
produce a higher resolution image based on the super-resolution algorithm and the low resolution image, the higher resolution image including the CSI of the first CC and the CSI of the second CC.

10. The electronic device of claim 8, wherein to determine the CSI of the second CC, the processor is further configured to:
transform the CSI of the first CC to a low resolution image in delay domain:
apply a super-resolution algorithm to the low resolution image based on a shifted windows (SWIN) transformer, wherein the signal predicting model is configured to: divide the low resolution image into non-overlapping windows in a SWIN transformer layer (STL), perform multi-head self attention (MSA) on pairs of STLs, first STL of each pair receiving the MSA and second STL of each pair receiving the MSA on cyclically shifted windows, concatenate outputs of the STLs, and perform final image mapping based on the outputs of the STLs; and
produce a higher resolution image based on the final image mapping, the higher resolution image including the CSI of the first CC and the CSI of the second CC.

11. The electronic device of claim 8, wherein the UE is one of a plurality of UEs and the processor is further configured to:
obtain a feature from CSI of a respective first CC, the feature including a power delay profile (PDP), a PDP correlation, a delay spread, an antenna correlation, or a Rician fading factor;
input the feature into a classifier;
determine that a CSI determination of a respective second CC is reliable based on an output from the classifier; and
select a UE, from the plurality of UEs, associated with the reliable CSI determination for the second CC.

12. The electronic device of claim 8, wherein the processor is further configured to:
train the signal predicting model based on dataset that has been improved by at least one of noise addition, phase perturbations, or delay circular shifts.

13. The electronic device of claim 8, wherein the processor is further configured to:
split the first CC into sub-bands;
transform the CSI in each sub-band into a delay domain;
perform phase correction on the transformed CSI; and
input the phase corrected CSI to the signal predicting model.

14. The electronic device of claim 8, wherein the processor is further configured to utilize the CSI of the second CC for applications including precoder design, scheduling, or resource allocation.

15. A non-transitory computer readable medium embodying a computer program, the computer program comprising program code that, when executed by a processor of an electronic device, causes the electronic device to:
receive channel state information (CSI) of a first carrier component (CC) from a user equipment (UE);
preprocess the CSI of the first CC; and
determine CSI of a second CC based on the preprocessed CSI of the first CC and a signal predicting model.

16. The non-transitory computer readable medium of claim 15, wherein the program code that, when executed by the processor of the electronic device, cause the electronic device to determine the CSI of the second CC comprises program code that, when executed by the processor of the electronic device, causes the electronic device to:
transform the CSI of the first CC to a low resolution image in delay domain;
apply a super-resolution algorithm to the low resolution image; and
produce a higher resolution image based on the super-resolution algorithm and the low resolution image, the higher resolution image including the CSI of the first CC and the CSI of the second CC.

17. The non-transitory computer readable medium of claim 15, wherein the program code that, when executed by the processor of the electronic device, causes the electronic device to determine the CSI of the second CC comprises program code that, when executed by the processor of the electronic device, causes the electronic device to:
transform the CSI of the first CC to a low resolution image in delay domain:
apply a super-resolution algorithm to the low resolution image based on a shifted windows (SWIN) transformer, wherein the signal predicting model is configured to: divide the low resolution image into non-overlapping windows in a SWIN transformer layer (STL), perform multi-head self attention (MSA) on pairs of STLs, first STL of each pair receiving the MSA and second STL of each pair receiving the MSA on cyclically shifted windows, concatenate outputs of the STLs, and perform final image mapping based on the outputs of the STLs; and
produce a higher resolution image based on the final image mapping, the higher resolution image including the CSI of the first CC and the CSI of the second CC.

18. The non-transitory computer readable medium of claim 15, wherein the UE is one of a plurality of UEs and further comprising program code that, when executed by the processor of the electronic device, causes the electronic device to:
obtain a feature from CSI of a respective first CC, the feature including a power delay profile (PDP), a PDP correlation, a delay spread, an antenna correlation, or a Rician fading factor;
input the feature into a classifier;
determine that a CSI determination of a respective second CC is reliable based on an output from the classifier; and
select a UE, from the plurality of UEs, associated with the reliable CSI determination for the second CC.

19. The non-transitory computer readable medium of claim 15, further comprising program code that, when executed by the processor of the electronic device, cause the electronic device to:
train the signal predicting model based on dataset that has been improved by at least one of noise addition, phase perturbations, or delay circular shifts.

20. The non-transitory computer readable medium of claim 15, further comprising program code that, when executed by the processor of the electronic device, cause the electronic device to:
split the first CC into sub-bands;
transform the CSI in each sub-band into a delay domain;
perform phase correction on the transformed CSI; and
input the phase corrected CSI to the signal predicting model.
